(19) United States
(12) Patent Application Publication
(10) Pub. No.: US 2002/0174248 A1
(43) Pub. Date: Nov. 21, 2002

(54) Method and system for communicating chat and game messages in a wireless network

(75) Inventor: Matthew J. Morriss, Fort Worth, TX (US)

Correspondence Address: MOTOROLA INC, 5401 NORTH BEACH STREET, MAILSTOP E230, FORT WORTH, TX, 76137

(73) Assignee: MOTOROLA, INC.

(21) Appl. No.: 09/859,167

(22) Filed: May 16, 2001

(51) Int. Cl. G06F 15/173

(52) U.S. Cl. 709/238; 709/204

(57) ABSTRACT

Chat and game messages are communicated with a plurality of wireless devices over a communication channel that is divided into frames where some frames communicate data addressed to a wireless device individually and other frames communicate data addressed to the plurality of wireless devices simultaneously. Messages directed individually to the wireless device are retrieved based on a personal address that is specific for each wireless device. On the other hand a global address, (address decoded by the plurality of wireless devices simultaneously) is assigned for chat or game messages, which are broadcast over the coverage area of a wireless network. In this way, the present invention uses the wireless bandwidth more efficiently by avoiding repeated transmission of chat or game messages to each wireless device.

### FIELD OF THE INVENTION

The present invention relates generally to the field of messaging. More particularly, the present invention relates to maintaining asynchronous chat and game sessions in a wireless network.

### BACKGROUND OF THE INVENTION

Today, many users of wired devices, (such as personal computers or workstations) and wireless devices (such as, Personal Digital Assistants, (PDAs), pagers, cellular telephones, etc.) are connected to the Internet. Generally, the users subscribe to services offered by various Internet Service Providers (ISPs), such as America Online and MSN. The services offered by the ISPs include the ability to send and retrieve files as well as messaging services.

Some of the most popular messaging services include e-mail and instant messaging (IM), which are supported over wired and wireless networks. E-mail, perhaps the most widely used service on the Internet, allows for non-real-time messaging between two users. On the other hand, IM, which allows a user to launch a message to another user, provides a substantially real-time messaging capability. Other known messaging services provide multiple simultaneous asynchronous sessions, such as conferencing and chat services. For example, Internet Relay Chat (IRC) or, simply “chat” provides informal communications among users of a communicating network. Chat allows two or more users to exchange messages, typically through “channels” or virtual “chat rooms,” which are maintained on one or more chat room servers operated by the ISPs. The chat room servers, which are accessible by the users via the Internet, provide the chat environment, including the mechanism for entering and exiting the chat rooms.

Only chat “participants” connected to the on-line service or other chat environment provided by one or more chat room servers can take part in the chat. Entering particular chat rooms is typically effected using a list or menu of currently available chat rooms, which are usually classified by topic. Any user may elect to join a public chat room and become a participant. Participants in a chat room receive all messages sent to the chat room and can decide to contribute input messages according to personal preference. A participant seeking to have private message communications with one or more other participants in an existing chat room can also set up a private chat room. Once an initiating participant sends a “query” or similar message to invited participants, the chat room server provides a separate chat room or channel not accessible by anyone that is not invited by those in the established private chat room. Once entered into a chat room, public or private, the participants engage in or monitor discussions on a particular topic in progress. Exiting a chat room is usually as simple as closing the chat window.

Typically, client stations, such as wireless devices or wired workstations or personal computers, execute general purpose chat “client” software that allows chat participants to access the chat room server. Many versions of chat client software, with varying functionality and communications protocols, are widely available on the Internet for download. The chat room server, which maintains a list of all chat room participants, sends the chat messages to all of the participating client stations. The client stations, which can be wired or wireless devices, receive the messages over designated wired or wireless links.

However, in chat rooms with a large number of participants, a large amount of chat room traffic in term of chat messages can be generated. The generated chat messages must be communicated to participants' wired or wireless devices. As a result, a sizeable link bandwidth can be consumed to support high chat room message traffic amongst the participants, mainly because each participant would receive the comments of all other participants. As is well known, link bandwidth is a valuable resource, especially in wireless communication networks.

Another area of interest being developed in wireless telecommunication relates to wireless gaming. Multi-player games for wireless devices often require the same game data to be sent to each player. However, wireless game data transmission to each player individually is not very efficient, as it uses up valuable bandwidth. This is especially true when much of the game data being transmitted is the same for all players of the game.

Various wireless protocols are used for one-way and two-way messaging, including transmitting and receiving e-mail and chat messages. One such system, which is disclosed in the U.S. Pat. No. 5,949,326, allows a pager user wireless access to the Internet via a paging system. The pager user may file an interest profile with the pager system service provider listing Internet sites from which the pager user desires information. The service provider accesses those sites and provide the information to the subscriber's pager either regularly or when signaled to do so by the pager user. The pager also includes an input device, such as a virtual keyboard, with which e-mail or chat room messages may be entered. The pager then transmits the messages to the paging system, which conveys them to the Internet.

Another paging protocol used for Internet messaging is the FLEX technology developed by Motorola Inc., the assignee of the present invention. FLEX and ReFLEX protocols, which specify a one-way and a two-way protocol, respectively, are adopted by many paging service providers worldwide. These protocols are multi-speed, high-performance paging protocols that organize the messages into frames of data. The ReFLEX and FLEX protocols are based on a “synchronous” time slot protocol, which is designed to increase the battery life of the pagers. Instead of sending out messages at random, all paging data intended for a particular pager is scheduled into a pre-defined time slot for transmission.

Most selective messaging systems, such as paging systems, are simulcast systems where a message is simultaneously or nearly simultaneously launched from each or all transmitters in a system over outbound channels. These simulcast systems provide excellent coverage in that a subscriber devices is very likely to receive any message intended for the device, regardless of the location of the device or lack of knowledge on the part of the system of its location. The system also includes receivers that receive inbound message traffic transmitted from the wireless devices.

Similar to wired Internet service providers, current wireless implementations transmit chat messages and game data individually to each and every one of the wireless devices that are involved in a chat session or game environment, thereby producing a large amount of traffic over the wireless links. Therefore, there exists a need to efficiently utilize wireless bandwidth to provide chat messaging and wireless gaming applications.

### DESCRIPTION OF THE DRAWINGS

FIG. 1 is a block diagram illustrating a system according to the present invention.

FIG. 2 is a block diagram of an exemplary wireless network that provides wireless links in the system of FIG. 1.

FIG. 3(a)-3(c) are timing diagrams for transmission of data in the system of FIG. 1.

FIG. 4 is a block diagram of a wireless device used by the system of FIG. 1.

FIG. 5 is a diagram depicting the flow of chat messages in the system of FIG. 1.

FIG. 6 is a conventional wireless network implementing a game environment.

FIG. 7 is a wireless network that implements a game environment according to the present invention.

FIG. 8 shows inbound game messages transmitted to the wireless network of FIG. 7.

### DESCRIPTION OF A PREFERRED EMBODIMENT

Briefly, according to the present invention, chat and game messages are communicated amongst a plurality of wireless devices over a communication channel that is divided into frames, where some frames communicate messages addressed to a wireless device individually and other frames communicate messages addressed to the plurality of wireless devices simultaneously. Messages directed individually to the wireless device are retrieved based on a personal address that is specific for each wireless device. On the other hand, a global address (address that is decoded by the plurality of wireless devices simultaneously), is assigned for chat or game messages, which are broadcast over the coverage area of a wireless network. In this way, the present invention uses the wireless bandwidth more efficiently by avoiding repeated transmission of chat or game messages to each wireless device.

According to some of the more detailed features of the present invention, the global address corresponds to an address used for providing such Information services as a financial, news, sports services, etc. According to other more detailed features of the present invention the chat or game messages are broadcast using either one of ReFLEX or SMS protocols. Also, the wireless devices transmit a response to a broadcast message, identifying a broadcast address to which the response is intended

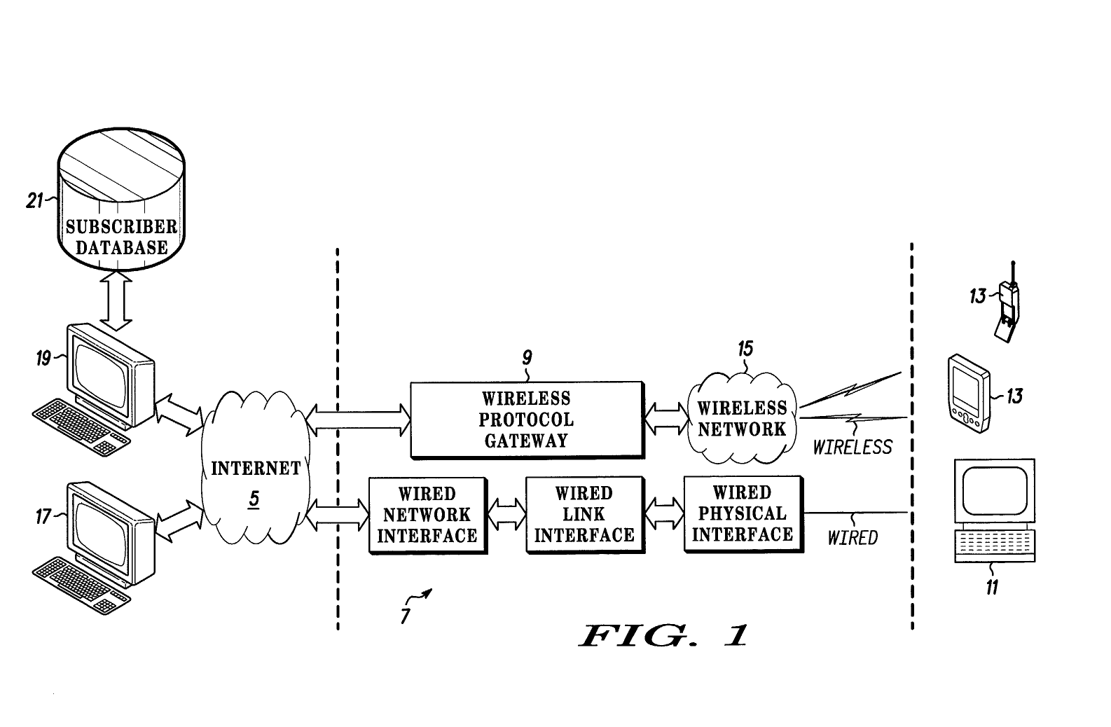

FIG. 1 shows a network interconnecting a plurality of wired devices 11 and wireless devices 13 to the Internet, for communicating chat and game messages in accordance with the present invention. The wired devices 11 access the Internet via a well-known wired Internet access network 7, such as a TCP/IP network. Each wireless device 13 is also provided with Internet access capability via a wireless network 15 connected to wireless protocol gateway 9. Examples of such wireless protocol gateway 9 are already defined or are in the process of being defined by such standard bodies as WAP Forum, 3GPP and 3GPP2. As such, in one exemplary embodiment, the wireless devices 13 may be in the form of WAP-enabled cell phones, two-way pagers, PDAs or any other type of device that wirelessly communicates information over a network. Also, the hardware platform for implementing the wireless network 15 can be any proprietary or standard hardware that supports wireless links with the wireless devices 13. Examples of such platform are those defined by Flex, ReFlex, IS-95, IS-136, iDEN, Bluetooth, GSM, GPRS, etc.

In accordance with a chat room messaging embodiment, each wired or wireless device 11, 13 is provided with capabilities to communicate chat messages via a chat room server 19, which is connected to the Internet 5. In accordance with another embodiment that relates to supporting game environments, a game server 17 is used for communicating game messages amongst the wireless subscriber devices 13. The chat room and game servers 19 and 17 can independently access a subscriber database 21, which stores subscriber related information and data. For communicating chat and game messages under one exemplary embodiment, the present invention supports any two-way wireless messaging/data protocol with broadcast messaging capability. The present invention can deploy any technology that supports PUSH protocols to send unsolicited messages to the wired and wireless devices 11, 13.

For the wired communication of messages, well-known IM over TCP/IP technology can be used, where the wired devices 11 execute known chat client applications, such as those developed by America Online. For wireless communication of messages, wireless messaging protocols include short messaging service (SMS) and ReFlex messaging protocol developed by Motorola Inc., the assignee of the present invention. As such, the wireless devices 13, acting as client devices, can execute wireless client applications that, for example, use wireless messaging over ReFLEX systems or short messaging service (SMS) over GSM and CDMA systems. Also the present invention can deploy future versions of chat over WAP with WAP PUSH protocols where a WAP User Agent running under the WAP application environment (WAE) would be executed in a wireless device 13. Although the protocols described above are examples of the protocols that can be used, the present invention can be applied with any other suitable standard or proprietary application protocol.

Using the arrangement described above, the chat room server 19 gives each of the wired or wireless devices 11, 13 the capability of sending/receiving or otherwise communicating chat messages with the other wired or wireless devices 11, 13. Upon receipt, the wired or wireless devices 11, 13 can immediately display the chat messages on a display device. Similarly, the game server 17 allows system subscribers to select from a variety of games and communicate game messages using wireless devices 13. The wired and wireless devices 11, 13 can also support buddy lists, which comprise lists with user identifications and statuses and/or locations of the users of each of the wired or wireless devices 11, 13. As described later in detail, the present invention avoids addressing chat room or game environment traffic to each recipient by sending such messages on a common broadcast channel. When a user selects a chat room or a game environment, the device begins receiving the data sent on that channel. Any number of users can receive the chat room or game messages traffic messages without increasing link bandwidth requirements.

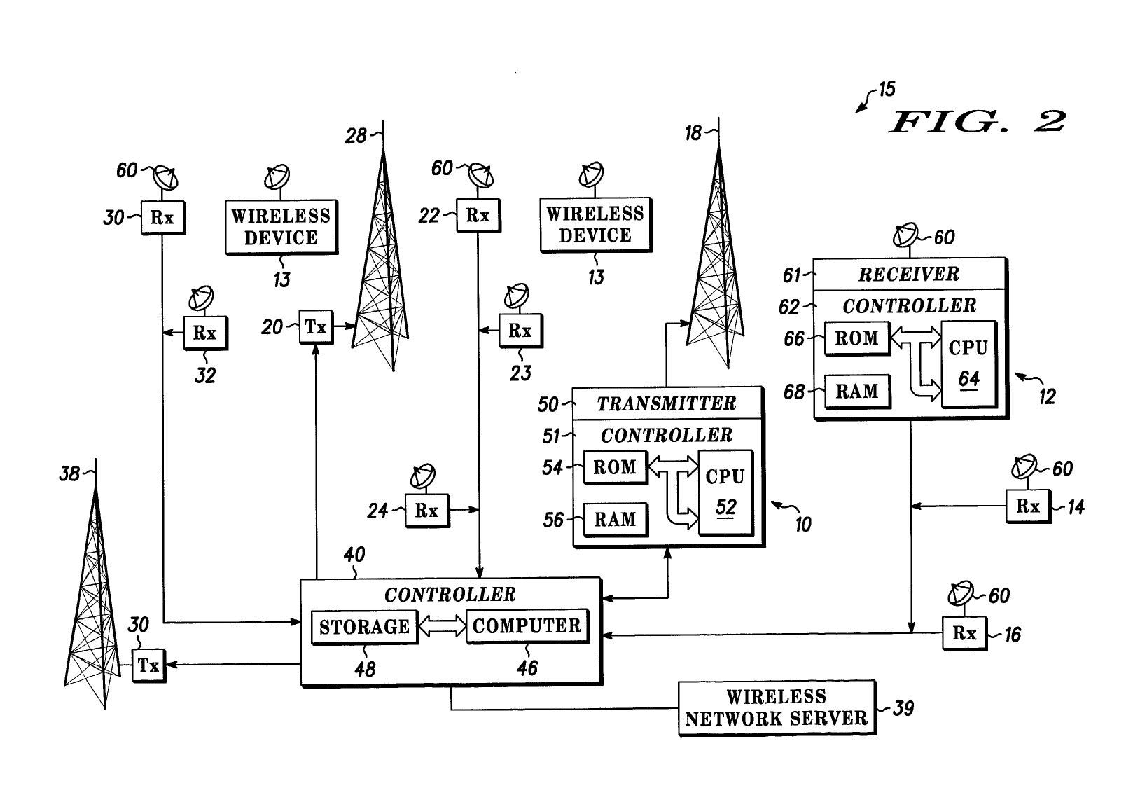

Referring to FIG. 2, a block diagram of an exemplary wireless network 15 that provides Internet access for wireless devices 13 of FIG. 1 is shown. As shown, the wireless network 15 includes a number of transmitter units 10, 20, 30 and receiver units 12, 14, 16, 22, 23, 24, 30 and 32. The transmitters and receivers are coupled to a controller 40 that schedules communications, i.e., transmissions or receptions, of data over repetitive time slots. The controller 40 assigns inbound and outbound frequency channels and schedules time slots for data transmissions to one or more wireless devices 13. The inbound channels are used for receiving data from the wireless subscribed devices 13 and the outbound channels are used for transmitting data to the devices. Exemplary wireless devices 13 include mobile radios, cellular telephones, pagers, etc.

In accordance with an exemplary embodiment, the wireless network 15 of FIG. 2 is a ReFLEX system offered by Motorola, Inc., the assignee of the present invention. However, other well known wireless networks, such as GSM, which support SMS protocol over TDMA or CDMA channels, can also be used with the present invention. In the ReFLEX system, the wireless devices 13 are instructed to access inbound channels through Block Information Words (BIW) and vectors, which are typically used to address and command the wireless devices 13 to perform various functions. A ReFLEX frame structure has a synchronization portion, a block information field (BIF) containing a frame information word, a Block information word (BIW), and a cyclic redundancy check (CRC) within the BIF. The CRC is used for bit error detection in the received BIW. An address field within an address portion follows the CRC and provides address information to the wireless devices 13 on a control channel. The address field points to a corresponding vector within a vector portion. The vector generally contains control information for a wireless device 13 regarding the location of a forward channel and the location of the message in a frame. For instance, a vector may contain a pointer that points to a message in the message field within an outbound message portion. In the ReFLEX protocol, the vector also contains inbound channel scheduling information regarding a subscriber device's acknowledgment response. The vector may also contain scheduling and control information for a wireless device 13 initiating a transmission on the inbound channel, such as the Start Address Unit Response, which is transmitted during the first time slot of a multi-slot data transmission.

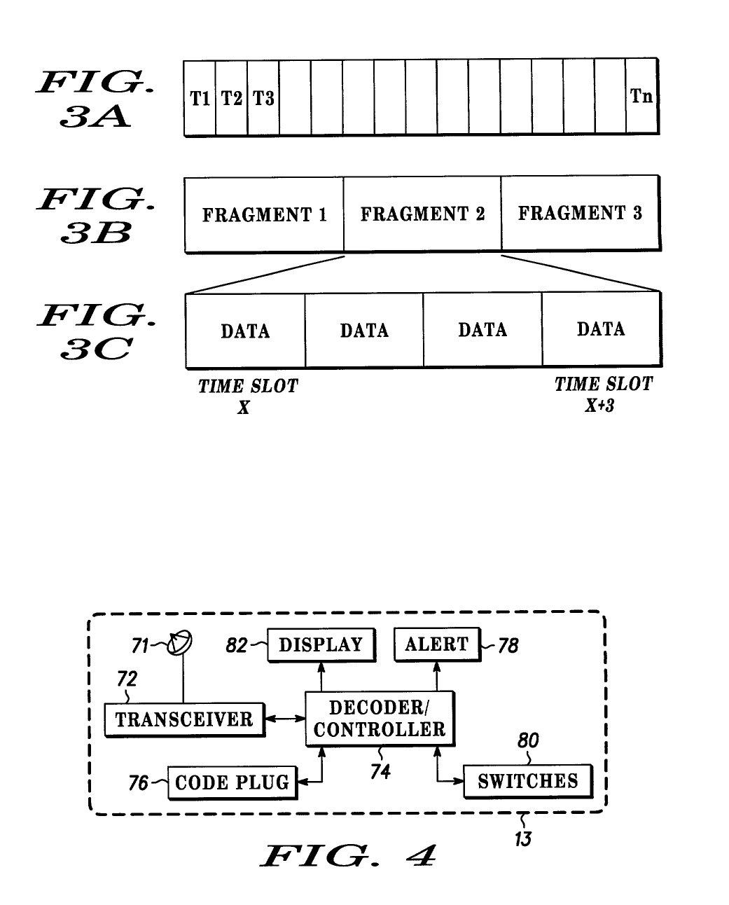

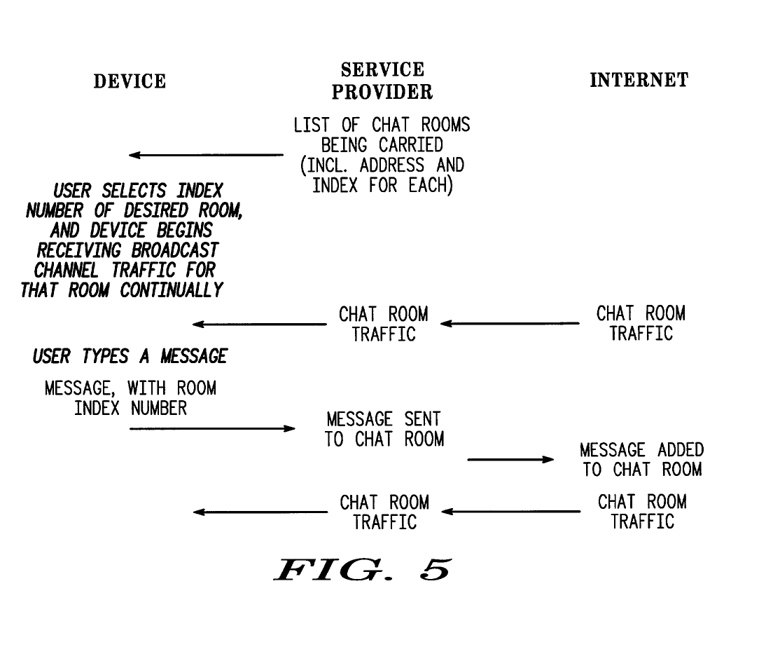

FIG. 3 shows a diagram of data packets divided into time slots T1-Tn, which are used for communicating messages. FIG. 3 shows the time slots being grouped to form fragments 1, 2 and 3. As shown in FIG. 3, each fragment includes a data portion. There are a total of 128 frames in a FLEX protocol system numbered zero through 127. The frames are transmitted at 32 frames per minute, and thus a full 128-frame cycle lasts four (4) minutes. This arrangement allows a FLEX-based wireless device to selectively decode one or more frames over each four minute FLEX cycle, so that the wireless device does not need to waste its battery life decoding data intended for other wireless devices.

Periodically, the system can send system configuration information to the wireless devices 13. In a FLEX system, each frame of data contains a BIW that informs the wireless devices 13 about system configuration. A BIW can preferably include information about modulation schemes (4 Level FSK, Spread Spectrum, QAM, FLEX, POCSAG, etc.), a boundary between scheduled and unscheduled slotted (ALOHA) transmissions, the maximum number of ALOHA retries allowed by the subscriber unit, the inbound (or reverse) channel speeds, the randomization interval for ALOHA transmissions, the ALOHA time out period, power levels, and many other communication parameters including but not limited to spread spectrum parameters such as hopping sequences, spreading gain or hopping frequencies.

Referring back to FIG. 2, in an exemplary communication application, the controller 40 communicates chat and game messages with the Internet or the like. The controller 40 includes a processor that operates in accordance with software and data stored in a memory for generating messages in accordance with a particular signaling protocol, for example, a four-level FSK signal protocol, such as REFLEX. The controller 40 schedules the transmission of the message over an outbound channel. Each of the transmitter units 10, 20, 30 of the network are positioned to maximize the area covered by message transmissions and to assure good signal quality.

Each of the transmitter units 10, 20, 30 includes a transmitter 50 and controller 51 as shown for the transmitter unit 10. The controller 51 of the transmitter unit includes a central processing unit (CPU) 52 that operates in accordance with software stored in a read only type of memory 54 and data stored in a random access type of memory 56 in order to control the operations of the transmitter unit 10, 20, 30. A queue that may be formed in a portion of the memory 56 of a transmitter unit 10, 20, 30 stores messages that are scheduled for transmission over an assigned outbound channel. The transmitter unit 10, 20, 30 transmits a message via a respective antenna 18, 28, 38 for reception by the wireless devices 13 in accordance with an identification of the devices, which are included in the transmitted messages.

The receiver units 12, 14, 16, 22, 23, 24, 30, and 32 of the network receive inbound message traffic transmitted from the wireless devices 13 over inbound channels. Each of the receiver units as shown for the receiver unit 12 includes an antenna 60 for receiving messages transmitted from the wireless devices 13 as well as a receiver 61 and controller 62 for demodulating and decoding the received data. The controller 62 of each of the receiver units includes a central processing unit 64 that operates in accordance with software stored in a read only type of memory 66 and data stored in a random access type of memory 68.

In order to perform the functions necessary for controlling operations of the system in accordance with the present invention, the controller 40 preferably includes a conventional computer system 46, and a conventional mass storage medium 48. The conventional mass storage medium 48 includes a data base comprising subscriber user information such as addressing and programming options of the wireless devices 13. The conventional computer system is preferably programmed by way of software included in the conventional mass storage medium 48 for performing the operations and features required in accordance with the present invention. It will be appreciated that other types of conventional computer systems can be utilized, and that additional computer systems and mass storage media of the same or alternative type can be added as required to handle the processing requirements of the system.

The storage medium 48 preferably includes software and various databases. In particular, the storage medium 48 includes a message scheduling, antenna control, and frequency reuse element which causes the controller 40 to schedule transmission and reception of messages in accordance with the present invention. It will be appreciated that the controller 40 and any transceiver comprising one or more receivers and transmitters can be either collocated or remote from one another, depending upon system size and architecture. It will be further appreciated that in large systems functional elements of the controller 40 can be distributed among a plurality of networked controllers. For example, the message scheduling, antenna control, and frequency reuse element can be located in one or more output controllers located near the transceivers, while the subscriber database can be kept in a controller at a central location.

A full implementation of the present invention uses chat and game services 19 and 17, which are independent of the wireless network 15 and exists to provide the chat or game service to subscribers. Such server can run the internet chat rooms provided by AOL, Yahoo, etc. Moreover, a wireless network server 39, which is maintained by a wireless provider as a part of the Wireless Network 15, is attached to the controller 40. The wireless server is connected as a virtual user to the chat room and game servers 19 and 17 for all active chat rooms and game rooms via the Internet 5 (shown in FIG. 1). The job of this server is to collect and format all chat or game messages from the server 17 or 19. The server 39 then forwards the formatted messages to the controller 40 to be sent to the wireless devices 13 on an appropriate broadcast addresses. Also, the server 39 receives from the controller 40 all chat contributions and game responses sent by wireless devices 13 and sorts the received messages to be forwarded to the appropriate chat server 19 or game server 17. Controller 40 is responsible for scheduling and sending all message traffic on the wireless network 15, and will blindly forward any messages from wireless users marked as chat or game data to the wireless network server 39. The controller 40 also accepts text messages from the wireless network server 39 and send them on the broadcast address specified by the server. The wireless network server 39 is therefore seen as either a collection of client connections or a single virtual user from the point of view of the servers 17 and 19, depending on whether the wireless devices 13 notify the wireless network server 39 when a subscriber participates in a chat room or game session. The wireless network server 39 could be an integrated part of the wireless network controller 40.

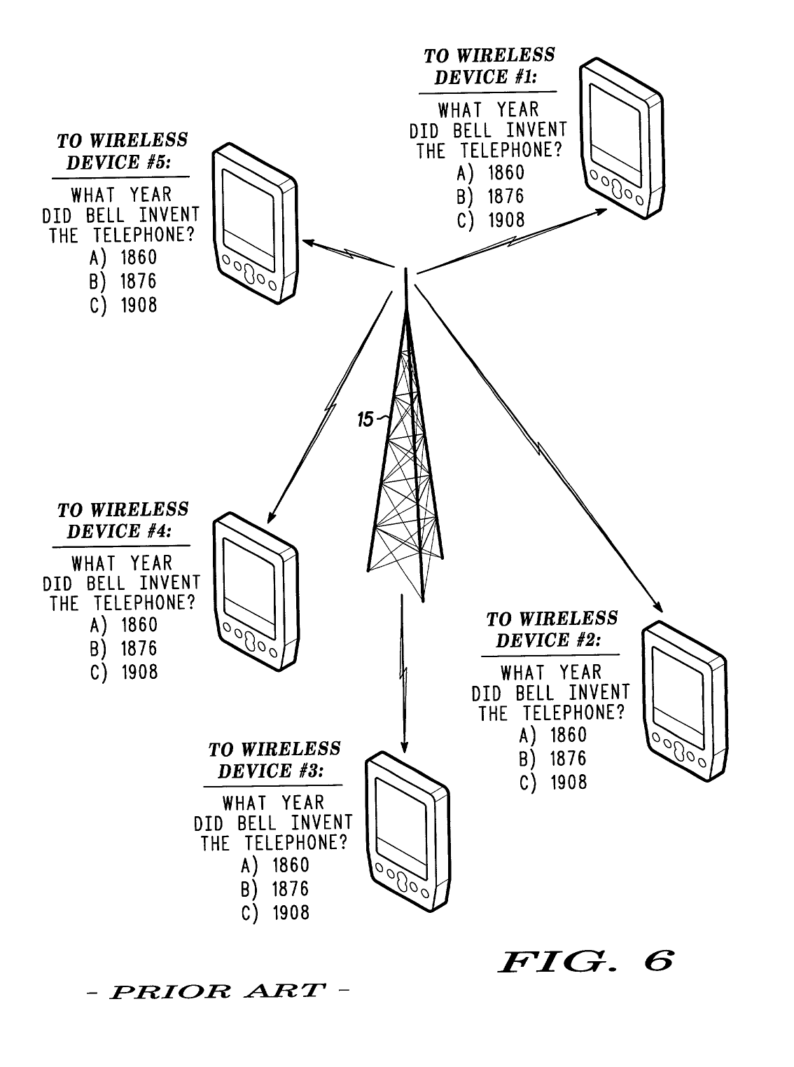

Referring to FIG. 4, a block diagram of a wireless device 13, which is depicted in an exemplary form as a mobile two-way selective call wireless device. The wireless device 13 includes an antenna 71 for receiving transmitted messages over outbound channels and for transmitting messages over one or more inbound channels. The antenna 71 couples a received signal to a transceiver 72 wherein the transceiver 72 produces a data stream representative of a demodulated received signal that is coupled to a decoder/controller 74. The transceiver 72 is also responsive to a modulation input such as data received from the decoder/controller 74 to frequency modulate a carrier signal for transmission out from the wireless device 13 to the receivers 12, 14, 16, 22, 23, 24, 30, and 32 over the inbound channels. As is well known in the art, the decoder/controller 74 may include a central processing unit such as a microprocessor or the like for processing demodulated signal information in accordance with software stored in a memory of the decoder/controller 74. The decoder/controller 74 is also responsive to inputs from one or more switches 80 or other input devices to generate data that is coupled to the transceiver 72 for transmission out from the wireless device 13. The RF signals transmitted by the transmitter units 10, 20, and 30 typically include an address that identifies a particular wireless access device 13 as well as an associated alphanumeric text and/or voice message. The decoder/controller 74 decodes a received address by comparing it with one or more addresses stored in a code plug or code memory 76. If the decoder/controller 74 detects a match between a received address and a stored address, an alert device 78 alerts a user that the wireless device 13 has received a message by generating an alert signal. The alert signal may be an audible and/or a tactile alert such as a silent vibrating alert. The switches 80 may be actuated by a user to select between the different types of alert's as well as for causing a message, e.g., a chat message, stored in the memory of the decoder/controller 74 to be accessed for display on a display 82. The switches 80 may also provide additional functions such as reset, read, delete, etc. as is well known.

A ReFLEX cycle is made up of frames that communicate personal data and global configuration information. Personal data are addressed to subscriber. In addition, a ReFLEX paging system may periodically send Information Service frames containing data that is not addressed to a particular wireless device 13. Instead, such frames are intended to be received simultaneously by any wireless device 13 programmed with a proper global address. Just as the wireless devices 13 may be configured to selectively decode only certain frames of personal message data, they may also be set to decode only particular Information service frames, independently of the personal frame setting. Messages sent in these frames are sent with a global address, rather than a personal address, and can be received by any subscriber device within range of the wireless network 15 that is configured to decode and display messages with that global address. Messages sent in this way are referred to in the ReFLEX protocol as Information Service messages, and are similar in nature and purpose to Broadcast SMS messages used in a GSM environment, which can be used as another embodiment for implementing the present invention. It is possible to mix personal and Information Service messages in a single frame on a ReFLEX system, as well as mixing data and configuration information in a single frame, so any frame may be used for communicating personal and Information Service messages.

A ReFLEX subscriber device may subscribe to more than one Information Service address. For example, in one exemplary system, known as Motorola ReFLEX25 system, the wireless device can be configured to support up to 16 different Information Service addresses simultaneously, whereas in another system known as Motorola ReFLEX50 system, 6 addresses each having 32 subaddresses may be supported, for a total of 192 possible Information Service channels. The system may of course send Information Service messages on many more addresses-this limit refers only to the maximum number of Information Service channels that can be received simultaneously by a given subscriber device. Traditionally, these Information Service channels, which are also referred to as global channels, are used to send news updates and other messages of general interest to a large number of subscribers. Such channels relate to Information Service messages with a particular address, sent on any messaging frame that any device on the system can receive

In the present invention, a number of these channels are used to broadcast chat or game messages to all users subscribed to a particular chat room or a game environment. It would be possible for an individual user of a wireless device to subscribe to more than one chat room or a gaming environment at a time.

As shown in FIG. 1, the system of the invention also includes a subscriber database 21 containing name, wireless address and user profile information for each subscriber devices 13, which is capable of running a chat or game client program.

In this specific ReFLEX example, a ReFLEX paging carrier may select any number of existing and new internet chat rooms or game environments for its subscribers, and assign an Information Service address to each of them. As stated above, the ReFLEX embodiment of the wireless network 15 is responsible for addressing and encoding information according to the ReFLEX protocol and sending it to the transmitter stations, which broadcast the information on outbound frequency channels.

In the chat room implementation of the present invention, the chat room server 19 can be subscribed to all Internet chat rooms that are accessible by subscribers. The chat room server 19 collects all chat room traffic from each of the chat rooms and forward it to the wireless network 15. The wireless network 15 then encodes the data for each chat room as a formatted text message, which is addressed to an Information Service channel specified by the chat room server 19. The format of the message is such that a wireless device 13, which is chat-enabled, recognizes the message as a chat room message.

A collapse value defines the frequency by which chat room traffic is collected and forwarded to the wireless network 15 for transmission. The collapse value is specific to each Information Service channel on which the chat message is sent. This frequency is configured by the network carrier, and may be a function of the amount of traffic in a supported chat room. That is, a busier chat room would more likely require an Information Service channel with a more frequent collapse value, so that information is forwarded to the wireless devices more frequently and in smaller packets than a chat room with less traffic.

In order to enable subscriber participation in a supported chat room on one of the Information Service channels, the wireless device may contain a menu that lists all Internet chat rooms for which an Information Service address is assigned. This list is sent to all chat-enabled subscriber devices 13 periodically, preferably in a specially coded message broadcast on one of the Information Service addresses to which all chat-enabled devices are subscribed. Each wireless device 13 processes the coded message and stores it in a protected area of its memory, to be updated any time the service provider alters the list of supported chat rooms. In one exemplary embodiment, the list contains, for each entry, the name of the chat room and the Information Service address on which it is carried. Moreover, the list contains any frame or channel information needed to receive messages on the address, for example, base frame and collapse value, and an index number used by the system to identify the chat room. The chat room server 19 creates this index number for each chat room, and updates the subscriber database 21 of FIG. 1, which matches each chat room to a corresponding address and index number.

Alternately, the subscriber may compose a profile message containing information identifying one or more subscribed chat rooms. The wireless device 13 then transmits the profile message to the chat room server 19. The chat room server 19 can then assign an Information Service address and index number for any subscribed chat room, which is transmitted back to the wireless device 13 as a personal message indicating the subscribed Information Service channels. In order to limit the number of chat rooms supported and thus the required bandwidth, the carrier can refuse subscription requests to chat rooms that are not already supported by the system.

Once the user of the wireless device selects a chat room to join, either by selecting the chat room from the stored chat room list or requesting it via the profile message, the wireless device 13 enters a dedicated ‘chat’ mode. In the chat mode, the wireless device 13 reconfigures itself to receive traffic from an appropriate Information Service channel. The specified Information Service address for such channel is added to the list of addresses to be decoded. The Information Service collapse value can also be adjusted so that all frames that contain the correct chat room traffic are decoded.

The client software causes the wireless device 13 to display the chat room messages on the screen in a similar fashion to existing wired Internet chat room clients. The subscriber wireless device does not need to notify the wireless network 15 or chat room server 19 when a chat room is entered, since the operation of accessing the Information Service address and displaying the data can be done entirely by the device, unless the service provider wishes to announce to the Internet chat room when a wireless user has joined. Preferably, the client software on the wireless device 13 provides a means of scrolling up through a message buffer, to allow the user to review the most recently received message data.

The client software on the wireless device also allows the user to compose messages to be contributed to the joined chat rooms. When the user composes such a message, the wireless device 13 transmits the message to the wireless network 15. In the ReFLEX network, the wireless device originated data is communicated using a specified reverse channel message format. The address field under the format indicates that the message is intended for the chat room server 19. The wireless network 15 also recognizes which user has sent the message based on an associated device address accompanying the message, and routes the information to the chat room server 19 along with the message. The wireless device 13 also includes the index number assigned to the chat room into the formatted chat room message. When the chat room server 19 receives this message, it uses this number to identify the chat room for which the message is intended. Alternately, the wireless device client could avoid the use of unique index numbers by returning the address of the subscribed Information Service channel to identify for which chat room the message contribution is intended. The received chat room messages at the wireless network 15 are transmitted to the wired chat room client via the chat room server 19.

The wireless network 15 database (preferably stored at storage medium 48)is used to determine the name of the chat participants based on the wireless device address and submit the message to the internet chat room, which is indicated by the index number included with the message. The name of the contributor retrieved at the wireless network 15 is attached to the message to identify the author to the other chat room members. In one exemplary arrangement, the service provider allows users to specify a handle, or nickname, to be stored in their profile for use in chat room contributions. Once the chat room server 19 has added the message to the chat room, the message is transmitted to all those who have joined the chat room, including the chat room server itself. The message is then retrieved by the chat room server 19 and forwarded to the wireless network 15, where it is sent to all other wireless devices 13 whose users have subscribed to that chat room. FIG. 5 shows the above described flow of chat messages. It will be appreciated that the present invention may be implemented without a wired network. A wireless carrier could elect to create its own chat rooms available only to its own subscribers, so that messages are shared network all wireless subscribers but are not forwarded to the internet. In this case, wireless server 39 fills the role of servers 17 and 19.

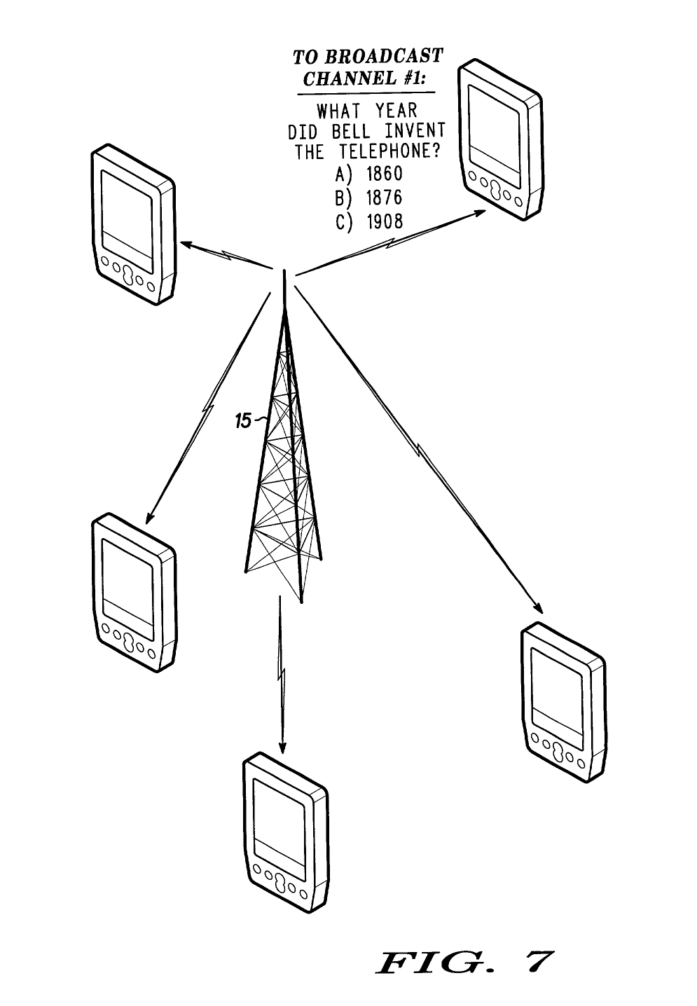

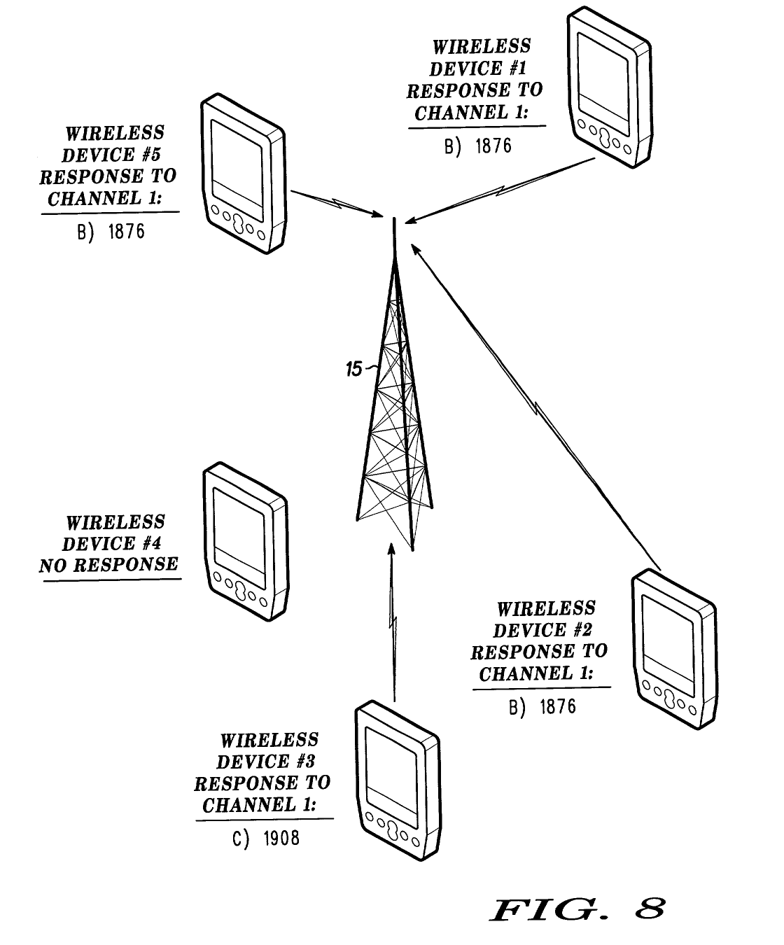

As stated above, according the another aspect of the invention, a system according to the invention can be used to provide a wireless game environment, where multiple players can enter the environment across a two-way data protocol that supports a broadcast channel. Examples of such games that can be implemented according to the present invention include a multiple choice trivia game where questions are sent out via broadcast message and players answer by sending a message back to the system. As shown in FIG. 6, conventional multi-player games for wireless devices often require the same data to be sent to each player. According to this aspect, the present invention avoids sending game messages separately to each player. Instead, the game messages are transmitted on a broadcast channel to multiple players at the same time, as shown in FIG. 7. When a user selects a game channel, the device begins receiving the game messages sent on that channel. In this way, any number of users can receive the game messages without increasing bandwidth requirements.

When the user of a device wants to play a game offered by the system of the invention, a game mode is entered and the device becomes configured to receive data on a broadcast channel associated with a selected game environment. Data relevant to all players in the game is sent via the broadcast channel to wireless devices subscribed to that address. More specifically, when a user wishes to play a game, the game is selected from a menu on the wireless device. The wireless device then enters the game mode, and begins receiving the appropriate broadcast channel data. In this way, game messages are sent by the system only once.

As shown in FIG. 8, when game messages are sent from the wireless device back to the system, for example, when the user presses a key that is interpreted by the game server 17, the device sends the game messages to the system via a reverse channel message, tagged to identify it as belonging to a game in progress. Each game that the system supports using this method has a code associated with it. If the system received a message from a user's device that has one of these codes, then the message is associated with the game and is passed on to the game server 17 to be processed according to the rules of the game.

What is claimed is:

1. A method of communicating messages with a plurality of wireless devices over a communication channel, comprising:
communicating a message using a personal address that is decoded by a wireless device individually; and
communicating at least one of a chat message and a game message using a global address that is decoded by the plurality of wireless devices simultaneously.

2. The method of claim 1, wherein the communication channel comprises at least one frame that communicates data addressed to the plurality of the wireless devices individually and an Information Service frame that communicates data addressed to the plurality of wireless devices simultaneously.

3. The method of claim 1, wherein the global address corresponds to an address used for providing an Information service.

4. The method of claim 1, wherein the at least one of a chat message and a game message is communicated using ReFLEX protocol.

5. The method of claim 1, wherein the at least one of a chat message and a game message is communicated using SMS protocol.

6. The method of claim 1, wherein communicating the at least one of a chat message and a game message comprises broadcasting such message to the plurality of wireless devices.

7. A communication system that communicates chat or game messages with a plurality of wireless device over a communication channel, comprising:
a server that creates at least one of a chat room and a game environment for the plurality of wireless devices;
a wireless network that communicates messages addressed to the plurality of wireless devices individually and communicates messages addressed to the plurality of the wireless devices simultaneously;
wherein the plurality of the wireless device decode a global address simultaneously in order to retrieve at least one of a chat message and a game message.

8. The system of claim 7, wherein the communication channel comprises at least one frame that communicates data addressed to the plurality of the wireless devices individually and an Information Service frame that communicates data addressed to the plurality of wireless devices simultaneously.

9. The system of claim 7, wherein the global address corresponds to an address used for providing an Information service.

10. The system of claim 7, wherein the at least one of a chat message and a game message is communicated using ReFLEX protocol.

11. The system of claim 7, wherein the at least one of a chat message and a game message is communicated using SMS protocol.

12. The system of claim 7, wherein the wireless network broadcasts the at least one of a chat message and a game message to the plurality of wireless devices.

13. The system of claim 12, wherein a wireless device transmits a response to a broadcast message identifying a broadcast address to which the response is intended.

14. A wireless device, comprising:
a receiver for receiving messages over an outbound communication channel;
a transmitter that transmits messages over an inbound channel; and a decoder that decodes a personal address for retrieving a message transmitted to the wireless device individually and decodes a global address for retrieving at least one of a chat message and a game message that is transmitted to a plurality of wireless devices simultaneously.

15. The wireless device of claim 14, wherein the outbound communication channel comprises at least one frame that communicates data addressed to the plurality of the wireless devices individually and an Information Service frame that communicates data addressed to the plurality of wireless devices simultaneously.

16. The wireless device of claim 14, wherein the global address corresponds to an address used for providing an Information service.

17. The wireless device of claim 14, wherein the at least one of a chat message and a game message is communicated using ReFLEX protocol.

18. The wireless device of claim 14, wherein the at least one of a chat message and a game message is communicated using SMS protocol.

19. The wireless device of claim 14, wherein the at least one of a chat message and a game message are broadcast to the plurality of wireless devices.

20. The wireless device of claim 19, wherein the transmitter transmits a respond to a broadcast message identifying a broadcast address to which the response is intended.
